(19) United States
(12) Patent Application Publication
(10) Pub. No.: US 2011/0053577 A1
(43) Pub. Date: Mar. 3, 2011

(54) METHODS AND APPARATUS FOR COMMUNICATING BY VIBRATING OR MOVING MOBILE DEVICES

(76) Inventors: Changkee LEE, San Diego, CA (US); Stephen A. SPRIGG, Poway, CA (US)

(21) Appl. No.: 12/551,549

(22) Filed: Aug. 31, 2009

(51) Int. Cl. H04M 3/00

(52) U.S. Cl. 455/418

(57) ABSTRACT

Methods and systems enable mobile devices to receive communications and inform users about received communications by vibrating based on a vibration pattern. The mobile device may inform a user about the type of communication, the identity of the communicator and the content of a message by generating vibrations according to preset vibration patterns. Vibration patterns may be implemented according to Morse code. The mobile device may also receive commands and instructions from the user in the form of accelerations (e.g., tapping or patting) of the mobile device. The mobile device may translate the accelerations into acceleration pattern data which may be compared to stored patterns or templates to determine a corresponding command. The mobile device may execute the command and verify the execution.

### FIELD OF THE INVENTION

The present invention relates generally to mobile devices, and more particularly to methods and apparatus for communicating by vibrating or moving mobile devices.

### BACKGROUND

Mobile devices have become an integral part of everyone's life and provide users with a myriad of services ranging from telephone, internet, text messaging, etc. The portability, convenience and capabilities of mobile devices have caused society to become dependent on its use for a wide range of utilities, including computing and communication. However, there are situations in which the ability to use a mobile device may be limited. In some situations, mobile device usage may be considered a nuisance requiring users to silence their devices. Additionally, there are situations when a user's ability to physically handle a mobile device is limited.

### SUMMARY

The various embodiment methods and systems can alert users to incoming communications using sender-specific or message-specific vibration patterns, and enable users to create and transmit communication messages by moving the mobile device. In an embodiment, a mobile device may receive a communication including communication data, and generate particular vibration patterns based on the communication data received. Communication data may include communication type, identity of the communicator and the content of the communication. In a further embodiment, a mobile device may generate a first vibration pattern to alert a user about the type of communication received; generate a second vibration pattern to alert the user about the identity of the communicator; and generate a third vibration pattern to inform the user about the content of the communication. In a further embodiment, pre-defined or custom vibration patterns may be used to receive and decipher communications. In a further embodiment, a mobile device may receive and store vibration pattern data using Morse code. In a further embodiment, vibration pattern data may be stored in time intervals or binary pattern formats.

In a further embodiment, users may be enabled to command the mobile device 100 to act by moving the mobile device. A mobile device may receive a command to perform a function, such as transmitting a communication message or turning off the device. Mobile devices may receive and store acceleration pattern data and commands corresponding to the acceleration patterns. Mobile devices may register and store the acceleration patterns by detecting movements of the mobile device using an accelerometer. A mobile device may receive and save a command corresponding to the stored acceleration pattern data. The mobile device may detect movements and translate the movements to acceleration pattern data. The received acceleration pattern data may be compared to the stored acceleration pattern data to translate the movements detected by the mobile device to commands related to those movements. If the movements match the acceleration pattern data, the mobile device may perform the command associated with the detected movements. In a further embodiment, a mobile device may store acceleration pattern data based on Morse code.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a mobile device suitable for use in the various embodiments.

FIG. 2 is a process flow diagram of an embodiment method for informing a mobile device user about received communications.

FIG. 3 is a process flow diagram of an embodiment method for informing a mobile device user about received communications.

FIG. 4 is a data structure diagram of an embodiment method for storing vibration pattern data.

FIG. 5 is a process flow diagram of an embodiment method for informing a mobile device user about the identity of a communicator.

FIG. 6 is a process flow diagram of an embodiment method for translating messages to vibration patterns.

FIG. 7 is a process flow diagram of an embodiment method for translating messages to vibration patterns based on Morse code.

FIG. 8 is a process flow diagram of an embodiment method for informing a mobile device user about received communications.

FIG. 9A is a process flow diagram of an embodiment method for downloading vibration patterns.

FIG. 9B is a process flow diagram of an embodiment method for generating and storing custom vibration patterns.

FIG. 9C is a process flow diagram of an embodiment method for generating and storing custom vibration patterns using Morse code.

FIGS. 10A and 10B are data structure diagrams for storing vibration pattern data according to an embodiment.

FIG. 11 is a process flow diagram of an embodiment method for assigning a communicator identity to a vibration pattern data.

FIG. 12 is data structure diagram for storing vibration pattern data for informing a user about the identity of the communicator according to an embodiment.

FIG. 13 is a process flow diagram of an embodiment method for assigning vibration patterns to communicators.

FIG. 14 is a process flow diagram of an embodiment method for activating the vibration motor.

FIGS. 15A and 15B are process flow diagrams of an embodiment method for communicating using acceleration patterns.

FIG. 16 is a process flow diagram of an embodiment method for registering custom acceleration patterns.

FIG. 17 is a data structure diagram of an embodiment method for storing acceleration pattern data and related communication data.

FIG. 18 is a network component diagram suitable for use with to the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “communication data” is used herein to refer generally to all data related to a communication received by a mobile device including such information as the type of communication (e.g. phone call, e-mail, SMS), the identity of the communicators and the content of the communication.

As used herein, the terms “mobile device” and “handheld device” refer to any one or all of cellular telephones, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, and similar personal electronic devices which include a programmable processor and memory and receiver circuitry for receiving and processing communication such as email, SMS and telephone calls.

Mobile devices have become an integral part of everyone's life and provide users with a myriad of services ranging from telephone, internet, text messaging, etc. The portability, convenience and capabilities of mobile devices have caused society to become dependent on their use for a wide range of utilities, including computing and communication. However, certain situations limit the use of mobile devices. Etiquette rules often require users to silence their devices. For example, the unrestricted use of mobile devices may cause disruption and annoyance in libraries, restaurants, public transportation vehicles, movie theaters, classrooms, meetings, etc. Recently, users are reminded about the rules of etiquette that applies to the use of their mobile devices. For example, in movie theaters, the audience is asked to turn off all cellular phones before a movie showing. Similarly, before an important meeting, the attendees may be asked to turn off their mobile devices to avoid disrupting the meeting. When complying with the etiquette rules, users cannot determine details of received communications. In this situation the user may have to either leave the meeting to respond to the communication or respond after the meeting is adjourned.

Additionally, there are situations in which the users' physical restraints may cause limitations on the users' abilities to utilize their mobile devices. For example, while carrying objects with both hands, a user may be unable to respond to a communication received until he puts down an object.

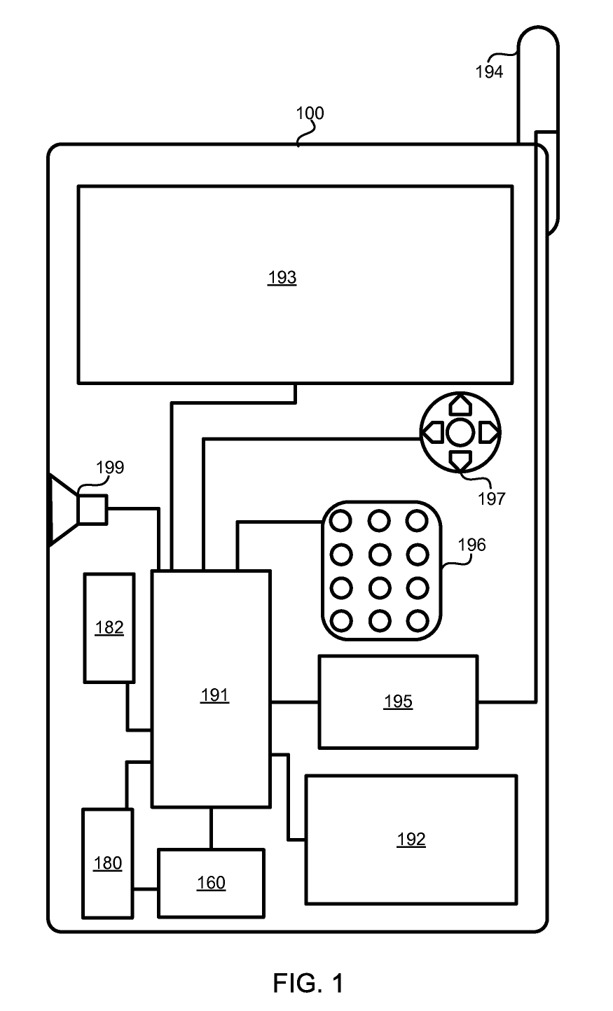

The various embodiment methods and systems enable mobile devices to silently communicate the identity of a caller or the nature of a message through particular vibration patterns. Typical mobile devices 100 suitable for use with the various embodiments will have in common the components illustrated in FIG. 1. For example, an exemplary mobile device 100 may include a processor 191 coupled to internal memory 192, a display 193, and to a speaker 199. Additionally, the mobile device 100 may have an antenna 194 for sending and receiving electromagnetic radiation that is connected to a wireless data link and/or cellular telephone transceiver 195 coupled to the processor 191. Mobile devices typically also include one or more user input elements for receiving user inputs and providing the inputs to the processor 191, such as a touch-screen display 193, a key pad 196 or miniature keyboard, and/or menu selection buttons or rocker switches 197. Additionally, the mobile device 100 may include a vibration motor 180 and an accelerometer 182 each coupled to the processor 191.

The mobile device 100 may include a battery 160 coupled to the processor 191 and the vibration motor 180. When connected to the battery 160 by the processor 191, the vibration motor 180 operates to generate vibrations. In the various embodiments, the processor 191 activates the vibration motor 180 in sequences to generate recognizable vibration patterns.

The accelerometer 182 may be configured to sense taps or movement of the mobile device 100 and provide information regarding the accelerations to the processor 191. In the various embodiments, the processor 191 is configured to receive such accelerometer signals and detect movement patterns that can be compared to pattern data stored in the memory 192 to determine if there is a match.

The processor 191 may be any programmable microprocessor, microcomputer or multiple processor chip or chips that can be configured with software instructions (applications) to perform a variety of functions, including the functions of the various embodiments described herein. In some mobile devices, multiple processors 191 may be provided, such as one processor dedicated to wireless communication functions and one processor dedicated to running other applications. Typically, software applications may be stored in the internal memory 192 before they are accessed and loaded into the processor 191. In some mobile devices, the processor 191 may include internal memory sufficient to store the application software instructions. In many mobile devices 100, the internal memory 192 may be a volatile or nonvolatile memory, such as flash memory, or a mixture of both. For the purposes of this description, a general reference to memory refers to all memory accessible by the processor 191, including internal memory 192, removable memory plugged into the mobile device, and memory within the processor 191 itself.

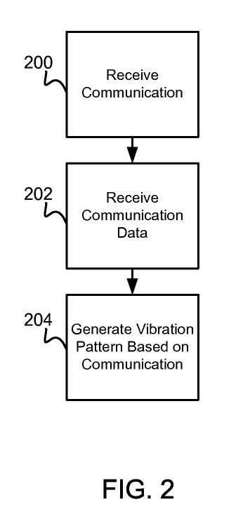

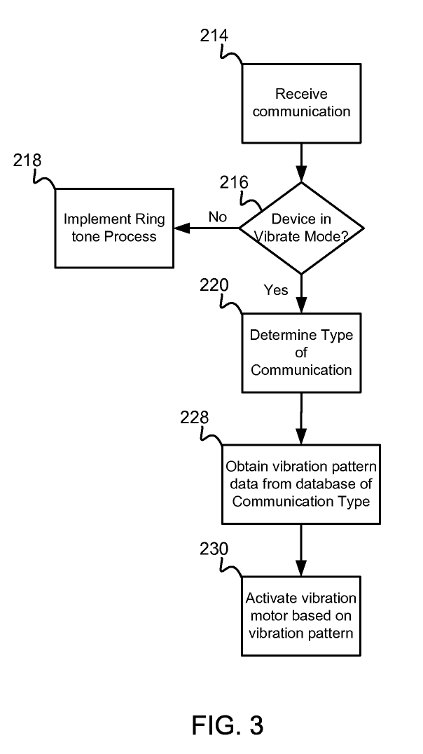

In an embodiment illustrated in FIG. 2, a mobile device processor 191 may be configured to receive communications via the wireless transceiver 195, step 200, and obtain communication data corresponding to the received communication, step 202. Communication data may include data about the type and urgency of a communication, such as an email, urgent email, SMS, urgent SMS, phone call, urgent phone call and local or long distant phone calls. The communication data may also include other information such as the identity and importance of the communicator (i.e., the individual or device initiating the communication) and the content of the communication. If the mobile device 100 is configured in a silent operation mode, the processor 191 may switch on the vibration motor 180 in a sequence or series of brief activations in order to generate a pattern of vibrations based on the communication data. A variety of different vibration patterns may be implemented in order to communicate information to the user about the nature of the communication, the identity of the communicator, and/or the content of the communication. Example embodiment methods for accomplishing each of these alternatives are described below with reference to FIGS. 3-8.

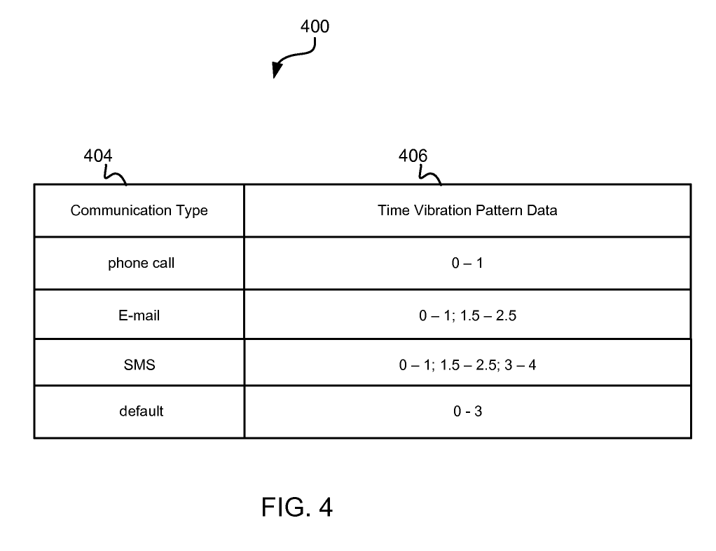

In an embodiment illustrated in FIG. 3, mobile devices 100 may be configured to alert users about the type of communication received using a particular vibration pattern. The type of communication may include the type of message/communication received (e.g., a phone call, SMS, MMS, or e-mail) and the urgency of the message. A mobile device 100 may receive a communication from a communicator, step 214, and its processor 191 may determine whether the mobile device 100 is in vibrate mode, determination 216. If it is not in vibrate mode (i.e., determination 216=“No”), the processor 191 may implement the ordinary ring tone process, step 218. If it is in vibrate mode (i.e., determination 216=“Yes”), the processor 191 may determine the type of communication received, step 220. The processor 191 may obtain a stored vibration pattern data from a database of vibration patterns by using the determined type of communication to locate a corresponding data record within the database, step 228. An example of such a vibration pattern database is described below with reference to FIG. 4. The processor 191 may activate the vibration motor 180 based on the vibration pattern, step 230. Thus, if the communication type received is an SMS message, the vibration pattern may include three vibrations each lasting for one second, for example. By feeling such a vibration pattern, the mobile device 100 user may determine that the communication received is an SMS message without having to look at the device display.

An example data structure suitable for storing vibration patterns correlated to communication types is illustrated in FIG. 4. Data records within a communication type data structure 400 may include information such a communication type 404, and time intervals for vibration pattern data 406. The communication types 404 data field may indicate the types of communications that a mobile device 100 may receive, such as phone calls, e-mails, SMS messages, or MMS messages. The time interval of the vibration pattern data 406 may include the time intervals during which the vibration motor is activated (i.e., vibrates) for each particular communication type.

A mobile device processor 191 may use the data structure illustrated in FIG. 4 to determine the vibration pattern to generate. For example, when a phone call is received and the mobile device 100 is in vibration mode, the processor 191 may recognize the type of communication received as being a phone call, use that information to locate the phone call data record (the first row in the table illustrated in FIG. 4), obtain the corresponding vibration pattern data from data field 406, and implement that pattern by causing the vibration motor 180 to vibrate a single time for one second (as indicated in the example data table). In another example, when an e-mail is received and the mobile device 100 is in vibration mode, the processor 191 may recognize the type of communication received as an e-mail, locate the appropriate data record to obtain the corresponding vibration pattern data, and implement the pattern to activate the vibration motor twice for one second each. As a further example, the vibration pattern data structure may include a default pattern that is implemented by the processor 191 when a communication type is not recognized or when a particular pattern type has not been assigned to a communication type. If the mobile device 100 receives a type of communication 404 not listed in the database 400, the processor 191 may cause the vibration motor to vibrate based on the default vibration pattern.

In the data table illustrated in FIG. 4, the time intervals of vibration pattern data 406 specify only the times during which the vibration motor should be activated. Thus, for other times the vibration motor will be off, so the mobile device 100 will be still. This data structure is for example purposes only and other formats for storing vibration patterns may also be used.

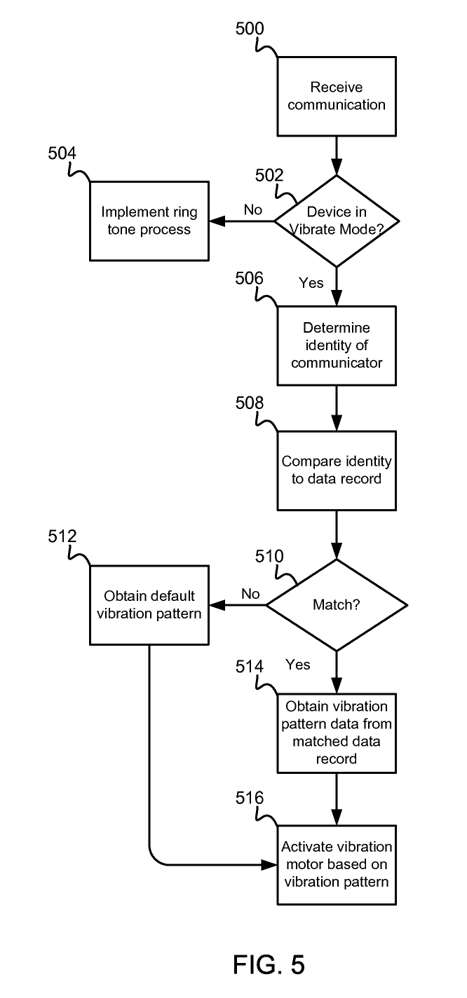

In an embodiment illustrated in FIG. 5, a mobile device 100 may be configured to vibrate in a particular vibration pattern to inform a user about the identity of a communicator (i.e., the originator of the received communication). A processor 191 may be configured with software instructions to receive communications, step 500, and determine whether the mobile device 100 is in vibrate mode, determination 502. If it is not in vibrate mode (i.e., determination 502=“No”), the processor 191 may implement a conventional ring tone process, step 504. If it is in vibrate mode (i.e., determination 502=“Yes”), the processor 191 may determine the identity of the communicator using identity information within the communication message, step 506. For example, the name of a caller, telephone number associated with an incoming phone call or an e-mail address associated with an e-mail message may be used to determine the identity of the communicator. The mobile device 100 may compare the identity information in the received communication to identities or identifiers stored in a database, such as a contact database, step 508, to determine whether there is a match, determination 510. If the identity information received in a communication does not match an identity or identifier in a stored database (i.e., determination 510=“No”), the processor 191 may obtain a default vibration pattern from memory, step 512, and activate the vibration motor 180 based on the default vibration pattern, step 516. If the identity information received in a communication matches an identity or identifier in a stored database (i.e., determination 510=“Yes”), the mobile processor 191 may obtain a communicator-specific vibration pattern data stored in the matched data record, step 514, and activate the vibration motor 180 based on the obtained communicator-specific vibration pattern, step 516. Using this embodiment, users may link specific vibration patterns stored in memory to specific contacts so their mobile device vibrates upon receiving a message or call in a manner that the users can recognize, thus informing them of the identity of the communicator without requiring them to look at the display or sound an audible ring tone.

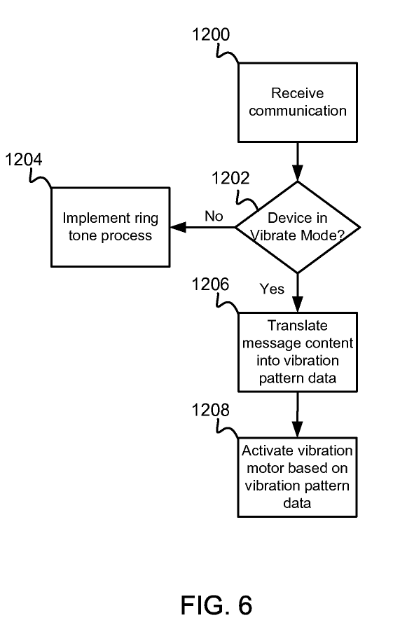

In an embodiment illustrated in FIG. 6, a mobile device 100 may be configured to use vibration patterns to inform a user about the content of a communication. The mobile device processor 191 may be configured with software instructions to translate received messages into particular vibration patterns which may be felt and understood by the user. For example, the processor 191 may cause the vibration motor 180 to vibrate based on Morse code to communicate content of messages to the user. A user knowledgeable about Morse code may feel the vibrations and understand the content of the message.

Referring to FIG. 6, the mobile device 100 may receive a communication, step 1200, and the processor 191 may determine whether the device is in vibrate mode, determination 1202. If the mobile device 100 is not in vibrate mode (i.e., determination 1202=“No”), the mobile device 100 may implement a conventional ring tone process, step 1204. If the mobile device 100 is in vibrate mode (i.e., determination 1202=“Yes”), the processor 191 may access the communication payload to obtain message contents and translate the message contents into vibration pattern data, step 1206. Using this vibration pattern data the processor 191 may activate the vibration motor 180, step 1208. A processor 191 may employ different methods in translating message contents into vibration patterns. For example, a processor 191 may translate messages using Morse code or vibration patterns reflecting a custom language.

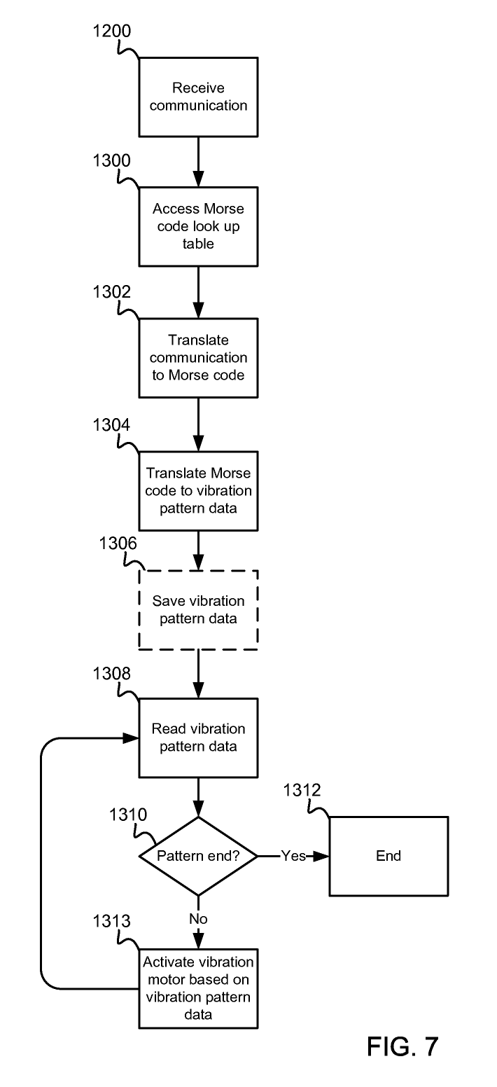

FIG. 7 illustrates an exemplary embodiment for using vibration patterns based on Morse code to inform a user about the content of a communication. When the mobile device 100 receives a communication, step 1200, the processor 191 may access a Morse code look up table, step 1300, and translate the message content into Morse code by looking up the Morse code for each letter in the content and forming a string of “dots” and “dashes”, step 1302. The processor 191 may then use the Morse code to generate matching vibration pattern data, step 1304. The vibration pattern data may optionally be saved, optional step 1306. The processor 191 may read the Morse code vibration pattern data, step 1308, so long as the end of the vibration pattern is not reached, determination 1310. If the vibration pattern is not ended (i.e., determination 1310=“No”), the processor 191 may activate the vibration motor 180 based on the read vibration pattern data, step 1313. The process of reading Morse code vibration pattern data and activating the vibration motor accordingly continues until the vibration pattern is ended (i.e., determination 1310=“Yes”), at which point the processor 191 may end the vibrations, thereby signaling the end of the communication content, step 1312.

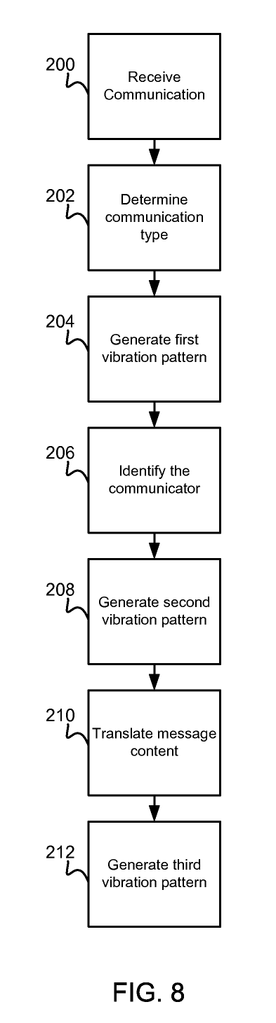

FIG. 8 illustrates an exemplary embodiment for enabling a mobile device 100 to inform a user about received communications using multiple vibration patterns. In this embodiment the mobile device processor 191 may be configured to receive a communication, and based upon the nature, originator and content of the communication, cause the vibration motor 180 to vibrate according to a first vibration pattern to inform the user about the communication type, then vibrate to a second vibration pattern to inform the user about the identity of the communicator, and then vibrate to a third vibration pattern to inform the user about the content of the communication.

When the mobile device 100 receives the communication, such as a phone call, SMS or an e-mail, step 200, its processor 191 may determine the type of communication, step 202, and generate a first vibration pattern based on the determined type of communication, step 204. The process of determining the appropriate vibration pattern and implementing the pattern may proceed in a manner similar to that described above with reference to FIG. 3. The mobile device 100 may also determine the identity of the communicator of the received message, step 206. The process of determining the appropriate vibration pattern and implementing the pattern may proceed in a manner similar to that described above with reference to FIG. 5. As described above, the processor 191 may compare the received communicator identity to data stored in a database and determine whether a match exists. For example, the mobile device 100 may be configured to compare the telephone number of an incoming call to the stored numbers in a phone number database. In another example, the mobile device 100 may be configured to compare the name of the communicator, for example, received in the caller ID information of an incoming phone call, to a name database stored on the mobile device 100. In yet another example, the mobile device 100 may be configured to compare the e-mail address of the communicator to a stored database of e-mail addresses. If a match is found between the identity of the communicator and one stored in a database, the mobile device 100 may then determine whether a preset second vibration pattern is associated with that communicator's identity. If there is a second vibration pattern associated with that communicator's identity, the mobile device 100 may generate vibrations according to the second vibration pattern, step 208. For example, a mobile device 100 user's spouse telephone number may be associated with a second vibration pattern such as three one-second long vibrations. When the mobile device 100 user feels a second vibration pattern of three one-second long vibration patterns, the user may determine that a message has been received from his/her spouse.

The mobile device 100 may also be configured with software instructions to translate the content of the message into vibration pattern data, step 210, and generate a third vibration pattern to inform the user of the content of the message, step 212. The process of determining the appropriate vibration pattern and implementing the pattern may proceed in a manner similar to that described above with reference to FIGS. 6 and 7. For example, the mobile device 100 may be configured with software instructions to translate the content of an SMS message into Morse code patterned vibrations. By implementing Morse code vibrations, the mobile device 100 may enable a user who understands Morse code to understand the content of a communication by simply feeling the third vibration patterns.

The vibration patterns used to inform the mobile device 100 users about communication data may be predetermined or custom defined. Mobile devices 100 capable of accessing the Internet may be able to download commercial vibration patterns through the Internet in a manner similar to how ring tones are downloaded today. Mobile devices 100 not capable of accessing the Internet, may receive predetermined vibration patterns through other modes, such as through program uploads. Alternatively or additionally, users may create their own custom vibration patterns. The mobile device processor 191 may be configured with software instructions to allow users to interact with the mobile device 100 to create custom vibration patterns and save them in the memory 192.

In an embodiment, the mobile device 100 processor 191 may be configured to receive a user-selected vibration pattern for a communication type. Accordingly, when a communication is received, the mobile device may determine the communication type (whether it is a phone call, email, SMS, etc.) and vibrate the vibration motor 180 to inform the user about the type of received communication.

In a further embodiment, the mobile device processor 191 may be configured to receive a user selected vibration pattern for identifying the identity of the communicator, such as the communicator's phone number or name, obtained from received communication data. For instance, when the user's mobile device 100 receives a phone call from the user's spouse, the mobile device 100 may inform the user about the communicator's identity by activating the vibration motor 180 in a pre-set vibration pattern which identifies the spouse.

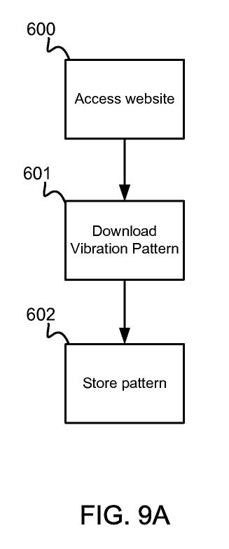

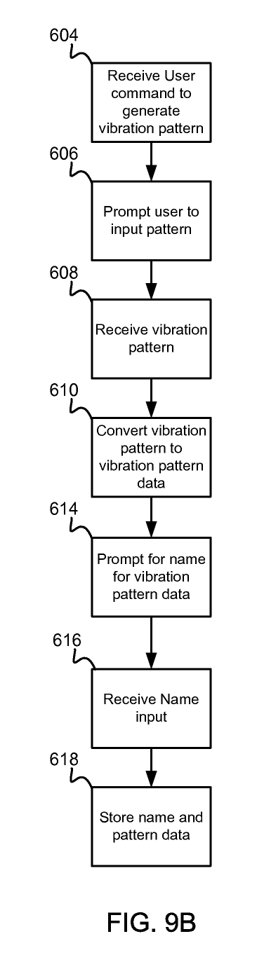

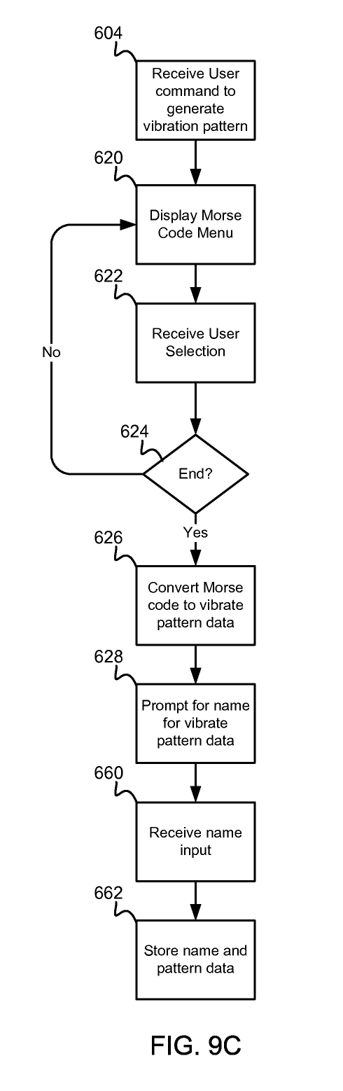

FIG. 9A illustrates an embodiment method for downloading vibration patterns from an Internet website. In this method, a mobile device 100 may access a website using the Internet, step 600, and select and download a desired vibration pattern, step 601. Once the vibration pattern is downloaded, the mobile device processor 191 may store the pattern in the memory 192, step 602.

FIG. 9B illustrates an embodiment method for creating custom vibration patterns and storing them in the mobile device 100 memory. The mobile device processor 191 may receive a user command to create a custom vibration pattern, step 604, and prompt the user to input the pattern using a graphical user interface, step 606. The processor 191 may receive the user's vibration pattern inputs, step 608. The processor 191 may allow a user to input a vibration pattern by starting a timer and request that the user input vibration patterns such as by pressing a button. For example, the processor 191 may direct the user to press a key for vibrations and release the key for no vibration with the length of time the user holds down or release a key indicating the duration of a vibration or no vibration interval. To create the vibration pattern the processor 191 may note the time intervals of button presses and releases until a pattern end symbol key, such as “#”, is pressed.

The processor 191 may then translate the noted time intervals into a data format, referred to herein as “vibration pattern data,” that can be stored in memory and used to recreate the vibration pattern indicated by the button presses, step 610. The vibration pattern data may be stored using different methods. For example, vibration patterns may be stored in binary or time interval pattern formats. The processor 191 may generate a display that prompts the user to designate a name for the entered vibration pattern data, step 614, receive the name input, step 616, and store the name and vibration pattern data in memory 192, step 618.

FIG. 9C illustrates an embodiment method for creating a custom vibration pattern using Morse code. A mobile device 100 may receive a user command to create a vibration pattern, step 604. Using a graphical user interface, the mobile device processor 191 may display a Morse code menu to the user from which the user may select a code pattern. Code patterns may be created to have meanings, such as a code pattern that spells S. O. S (i.e., help). Alternatively, code patterns may be a string of codes that have no real meaning under conventional Morse code translations. The processor 191 may receive the user code selections, step 622, and after each selection determine whether the code pattern has reached an end, determination 624. A user may indicate the end of the code pattern by, for example, selecting a soft key entitled “End” on the graphical user interface display. If the code pattern is not ended (i.e., determination 624=“No”), the processor 191 may receive the next code selection. If the code pattern is ended (i.e., determination 624=“Yes”), the processor 191 may convert the code pattern to vibration pattern data, step 626, and prompt the user to name the vibration pattern data, step 618. The processor 191 may receive the name input from the user, step 660, and stored the name and the vibration pattern data in memory 192, step 662.

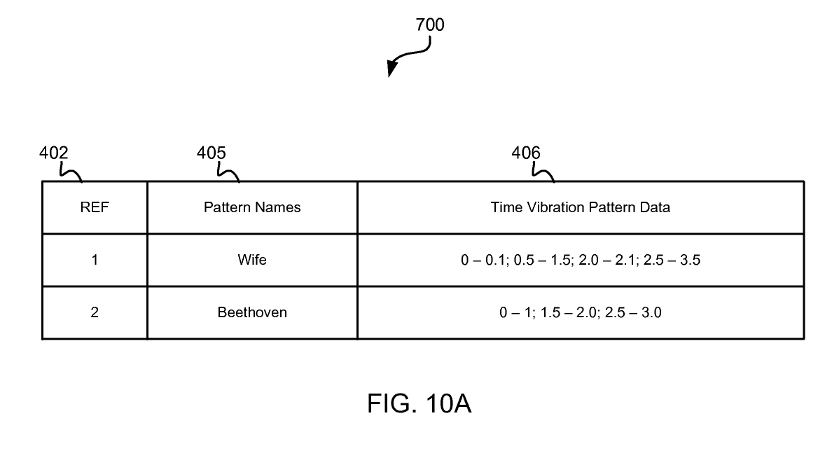

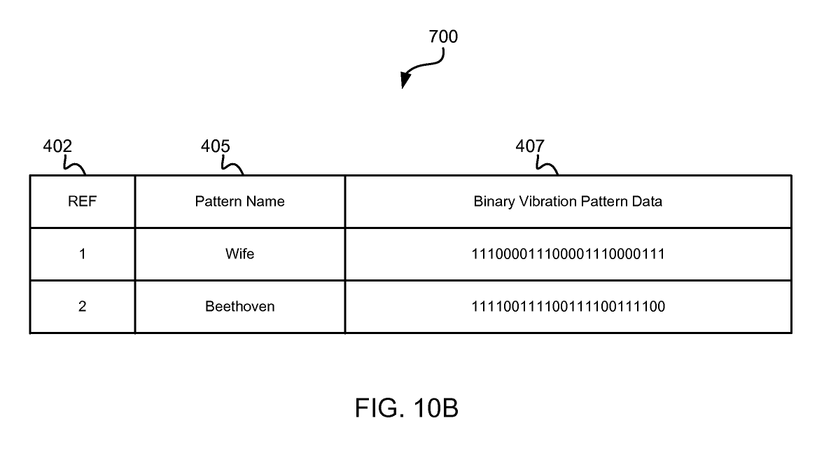

FIGS. 10A and 10B illustrate exemplary data structures for an embodiment vibration pattern data table 700. As illustrated in FIG. 10A, the vibration pattern database 700 may include reference numbers 402, pattern names 405, and time variation pattern data 406. Reference numbers 402 may be used to link vibration patterns to contacts. For example, the reference number may be stored in a contact record data file to indicate that the vibration pattern with that reference number should be activated when a message or call is received from that contact. The pattern names 405 may include the names assigned to the vibration pattern. When vibration patterns are downloaded, each may already include a name. However, the mobile device 100 user may also assign a custom name to each downloaded vibration pattern before storing it in memory. Custom vibration patterns may also be named by the mobile device 100 user as described above. The time vibration pattern data 406 may include the time intervals during which the vibration motor may be on or off. For example, the vibration pattern of reference “1” refers to the pattern name “Wife” and includes time vibration pattern data including a period of 0.1 seconds of first vibration, followed by 0.4 seconds of no vibration, followed by one second of a second vibration, followed by 0.5 seconds of no vibration, followed by 0.1 second of a third vibration, followed by the 0.4 seconds of no vibration and followed by one second of a fourth vibration. A mobile device 100 user may assign this vibration pattern data to a contacts database record for his wife so the pattern will be implemented when his wife calls or sends an SMS or email. This way, for instance, when the user receives a call from his wife, the mobile device 100 may vibrate according to the time vibration pattern data 406 for “Wife” to allow the user to know that the caller is his wife by feeling the vibration patterns.

FIG. 10B illustrates a data structure for storing vibration pattern data using a binary format. In this embodiment, instead of time intervals, binary data is used to store the vibration pattern data. For example, the binary symbol “1” may represent a vibration for 0.2 seconds and the binary symbol “0” may indicate a lack of vibrations for 0.2 seconds. Thus, the mobile device processor 191 may be configured with software to read the binary vibration pattern data 407 of reference “1” as 0.6 seconds of vibration, followed by 0.8 seconds of no vibration, followed by 0.6 seconds of vibration, followed by 0.8 seconds of no vibration, followed by 0.6 seconds of a third vibration, followed by 0.8 seconds of no vibration, followed by 0.6 seconds of a fourth vibration. The example data structure shows that the mobile device 100 user has named this pattern “Wife.” The user may assign this vibration pattern data to a contacts database record for his wife so the pattern will be implemented when his wife calls or sends an SMS or email. When a communication is received from the user's wife, the mobile device 100 may cause the vibration motor to vibrate according to the vibration pattern based on the binary vibration pattern data of reference “1”.

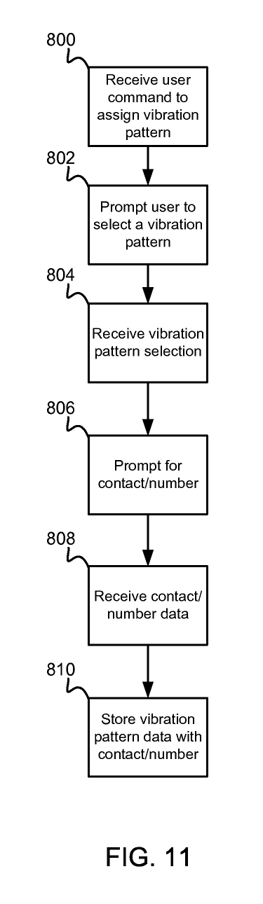

Commercial or custom vibration patterns stored in memory may be selected by the mobile devices 100 users for assignment to their contacts. FIG. 11 illustrates an embodiment method for assigning stored vibration pattern data to particular contacts. The mobile device 100 may receive a user command to assign a vibration pattern to a contact, step 800. The mobile device processor 191 may generate a display that prompts the user to select a vibration pattern stored in the memory, step 802, and receive the user's vibration pattern selection input, step 804. The processor 191 may generate another display that prompts the user to input a contact's information, step 806, and receive that information input, step 808. The mobile device 100 may store the vibration pattern data with the contact information provided by the user in a suitable database or data table, step 810.

It should be noted that the order of the steps shown in the figures is arbitrary and may be performed in a different order than presented. For example, in FIG. 11, the steps for prompting the user for a contact number may be performed before prompting the user to input the vibration pattern.

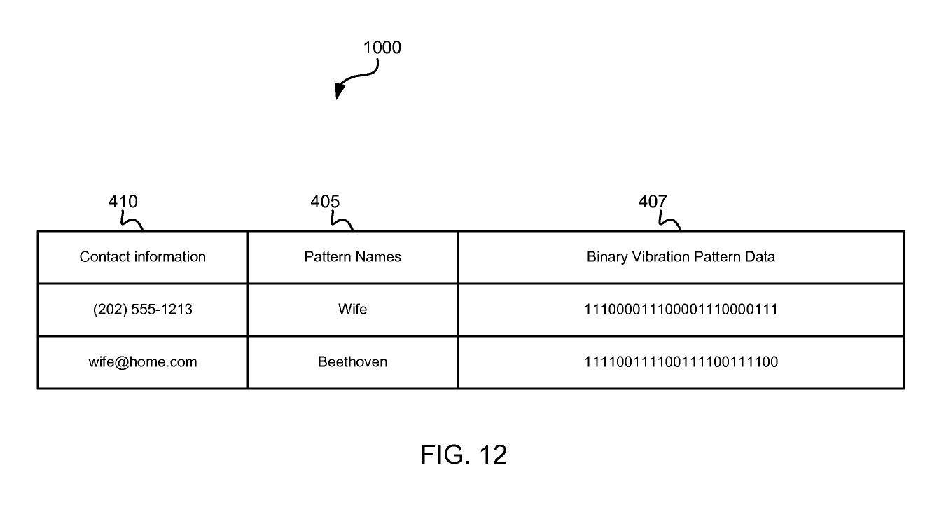

FIG. 12 illustrates a data structure for storing assigned vibration pattern data with contact information according to an embodiment. The data structure 1000 may include the contact information 410, pattern names 405, and vibration pattern data 407. The contact information 410 may include phone numbers, e-mail addresses, or names. The pattern names 405 may include the name designated by the user for the vibration pattern data, and the vibration pattern data 407 may include the data used by mobile device processor 191 to cause the vibration motor 180 to vibrate according to the desired vibration pattern. In this example, the vibration pattern data is in binary format. For example, in FIG. 12 the phone number “(202) 555-1213” contact information 410 corresponds to the pattern name 405 entitled “Wife” and binary vibration pattern data 407 includes four vibration periods equal in length interspersed by four periods of no vibrations that are equal in length. Accordingly, when a phone call from “(202) 555-1213” is received, the mobile device 100 implementing the data structure shown in FIG. 12 may vibrate according to the binary vibration pattern data 407 assigned to this telephone number.

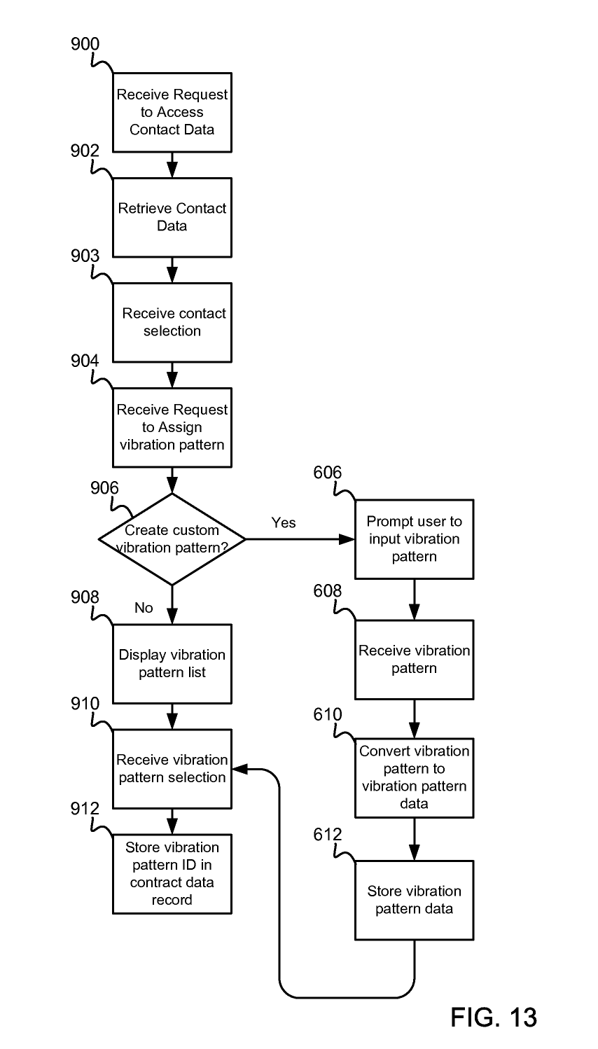

FIG. 13 illustrates an embodiment method for assigning vibration pattern data to records within a contact database. A mobile device 100 may receive a request from the user to access the mobile device's contacts database, step 900. The mobile device processor 191 may retrieve the contacts data, step 902, and display it to the user using a graphical user interface. The processor 191 may receive the user's selection of a contact, step 903, and a user input requesting assignment of a vibration pattern to that contact, step 904. The processor 191 may determine whether the user desires to create a custom vibration pattern, determination 906. If the user desires to assign a pre-stored vibration pattern to a contact (i.e., determination 906=“No”), the processor 191 may generate a display of a list of vibration patterns, step 908, from which the user may select a vibration pattern to be assigned to the contact. The processor 191 may receive the vibration pattern selection input, step 910, and store the vibration pattern data reference number within the contact data record, step 912.

If the processor 191 determines from user inputs a desire to create a custom vibration pattern to be assigned to a contact (i.e., determination 906=“Yes”), the processor 191 may generate a display prompting the user to input the vibration pattern, step 606. The processor 191 may receive the vibration pattern inputs, step 608, and convert the received vibration pattern inputs into vibration pattern data, step 610, in a manner similar to that described above with reference to FIG. 9B. The processor 191 may store the vibration pattern data in the mobile device's memory 192, step 612, and store the vibration pattern's reference ID in the selected contact data record, step 912.

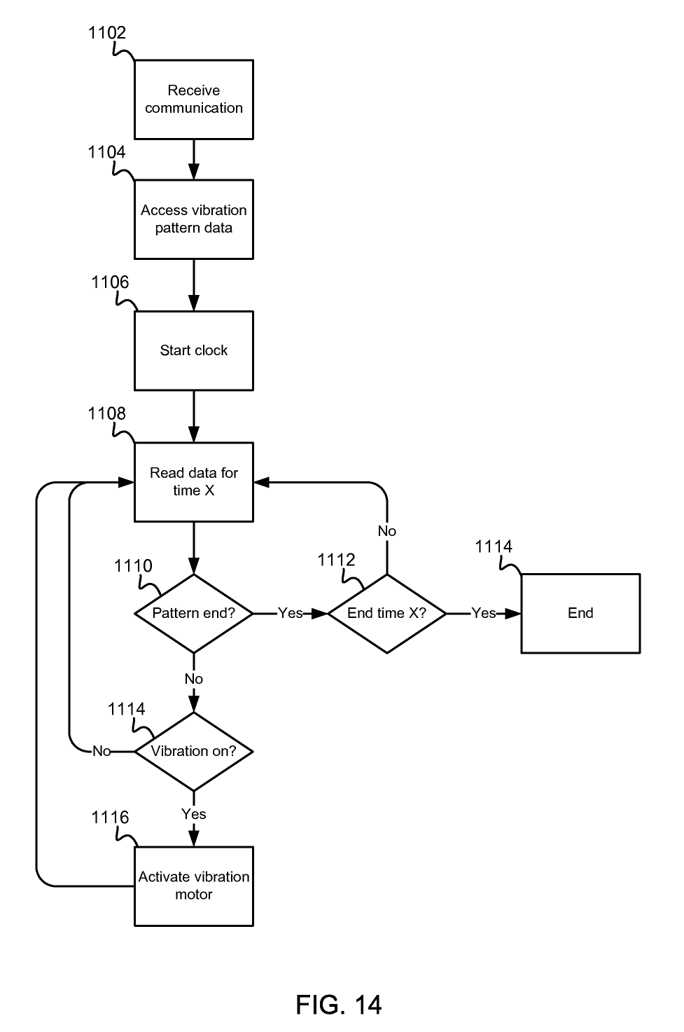

FIG. 14 illustrates an embodiment method for implementing vibration patterns based on vibration pattern data. The mobile device 100 may receive a communication, step 1102. Based on received communication data the processor 191 may access a vibration pattern data corresponding to the communication data, step 1104. To implement the vibration pattern, the processor 191 may start a clock, step 1106, and begin reading and implementing the vibration pattern data for a period of time, step 1108. The time period during which the mobile device 100 may read the vibration pattern data may be set using different methods. For example, a user may require that a vibration pattern data is read repeatedly for two minutes. Alternatively, the user may set the number of times a vibration pattern data may be repeated.

As described above, the vibration pattern data may be in the form of binary symbols or time intervals. If the vibration pattern data is in binary format, the mobile device 100 may be configured to read the binary bits (i.e., either symbol “1” or “0”) one at a time and implement a vibration or no vibration for a set period of time for each binary value. If the vibration pattern data is in a time period format, the mobile device 100 may be configured to read the time periods and activate the vibration motor at the indicated time periods. After reading each binary bit or time period the mobile device 100 may determine whether the vibration pattern has ended, determination 1110. If the vibration pattern is not finished (i.e., determination 1110=“No”), the mobile device 100 may determine whether the last bit or time interval indicates that vibration is on, determination 1114. If the last bit or time interval read by the mobile device 100 indicates a vibration (i.e., determination 1114=“Yes”), the mobile device 100 may send a signal to the vibration motor 180 to cause it to vibrate, step 1116. The mobile device 100 may then read the next bit or time interval in the vibration pattern data, step 1108. If the next bit or the time interval indicates a no vibration period (i.e., determination 1114=“No”), the mobile device 100 may read the next bit or time interval in the vibration pattern data after the expiration of the time period associated with the current bit or time interval, returning to step 1108.

If the vibration pattern has ended (i.e., determination 1110=“Yes”), the mobile device 100 may determine whether the overall designated time period (or repetition) is also ended, determination 1112. If the overall time period has not ended (i.e., determination 1112=“No”), the mobile device 100 may repeat the pattern by reading the vibration pattern data from the beginning, returning to step 1108. If the overall time period is ended (i.e., determination 1112=“Yes”), the mobile device 100 may end the vibration pattern implementation, step 1114.

While the foregoing descriptions refer to implementing vibration patterns to communicate with a user when the mobile device 100 is in vibrate mode, the use of vibration patterns may also be combined with audible signaling to communicate more information to the user. For example, the mobile device 100 may be configured, such as with a user setting, to emit a beep, sound or ring tone to alert the user of an incoming phone call or message, and then vibrate according to preset patterns to communicate the nature, content, author or caller to the user silently. This implementation may be beneficial for users by alerting them to the need to pay attention to the vibration pattern or to pick up the mobile device to feel its vibrations. Thus, while the mobile device may emit a sound that others may hear, the user alone is informed of the message contents or caller's identity. As described above, the message contents and caller identity may be communicated as preset patterns, or an alphabet of recognizable vibration patterns such as Morse code or a user-defined vibration alphabet.

In a further embodiment, a vibration alphabet template used to translate messages into recognizable vibration patterns may also be used to emit sounds, such as beeps or tones, in a similar manner so that a user fluent in the vibration alphabet may understand the message content by listening to the mobile device. In this embodiment, the vibration pattern databases and methods for translating a message into vibration patterns described above may be implemented except that in an audible mode the patterns are used to activate the mobile device speaker. Thus, if the mobile device is configured to use Morse code or a user-defined alphabet for translating messages into vibration patterns, the same processes for parsing and translating the message into code symbols may be used to emit long and short sounds according to the code.

In yet a further embodiment, the mobile device may be configured to enable a user to set ring tone and vibration pattern settings so that the mobile device emits a user-specified combination of beeps, tones, ring tones, and vibrations to translate a message into a cacophony of sounds and vibrations that only the user can understand, such as a user defined code or language.

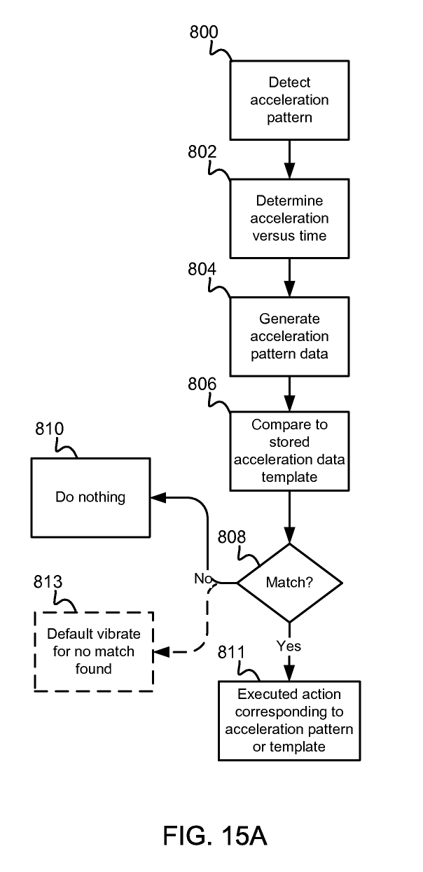

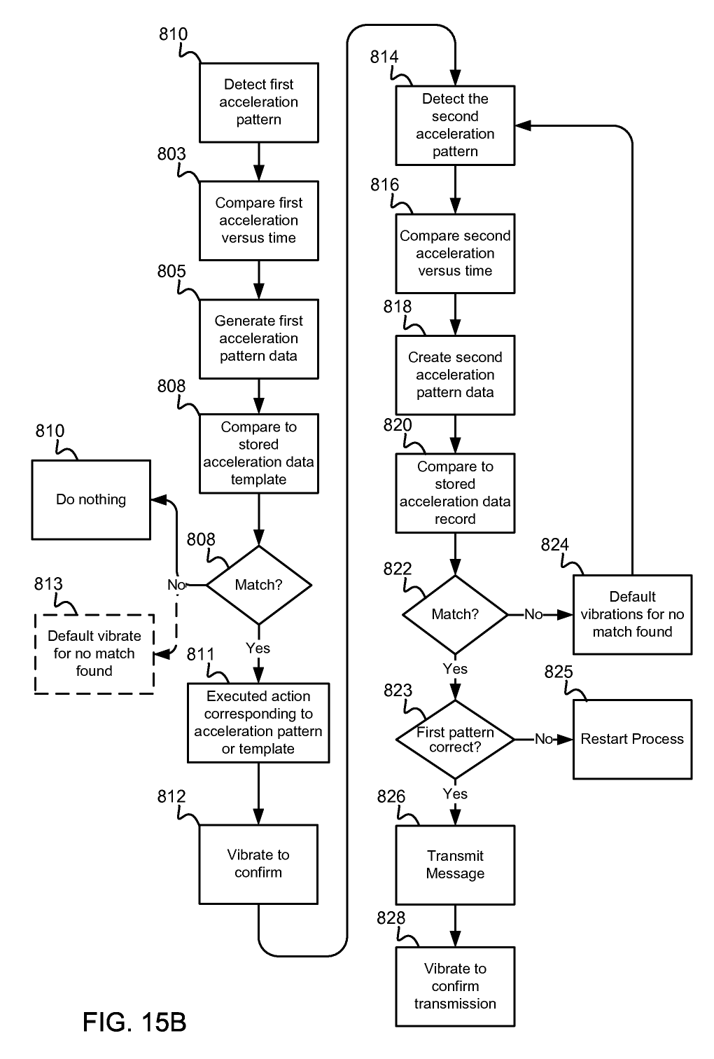

In a further embodiment method described below with reference to FIGS. 15A-17, a mobile device 100 may enable a user to respond to a received communication by moving the mobile device 100, such as by tapping or shaking the device. Acceleration patterns may be produced by moving a mobile device 100 equipped with an accelerometer 182, such as by tapping or patting the device with a finger or palm. The mobile device processor 191 may be configured to receive and analyze data from the accelerometer 182 to detect the movements produced by the user and generate acceleration pattern data. The mobile device 100 may then determine the meaning of the acceleration pattern data by comparing the data to a set of stored acceleration pattern data or templates.

Acceleration pattern data stored in a database accessible to a mobile device processor 191 may be assigned to different predefined messages stored in memory. Stored acceleration pattern data may be assigned to commands which may include instructions for creating and transmitting a communication message. Upon receiving accelerations and determining that the received acceleration patterns match a pattern or template stored in an acceleration pattern data database, the processor 191 may compose and send the predetermined communication to the person associated with the matched pattern or template.

In an embodiment illustrated in FIGS. 15A and 15B, a mobile device processor 191 may be configured to detect a motion, and based on the motion compose and transmit a communication/message. For example, when a user desires to send an email to his wife to let her know that he is in a meeting and will call her later, he may shake his mobile device 100 twice in a 1 second period. The mobile device 100 may detect the motion and translate it to mean a command to compose and send an email message to “wife” including the message “I am stuck in a meeting. I will call you later.”

As illustrated in FIG. 15A, the mobile device processor 191 may be configured with software instructions to detect an acceleration pattern (e.g., accelerations vs. time) within data received from an accelerometer 182, step 800. The processor 191 may compare the acceleration patterns versus time, step 802, to generate acceleration pattern data, step 804. The mobile device 100 may compare the generated acceleration pattern data to acceleration pattern data or templates stored in a data table, step 806, to determine whether there is a match, determination 808.

If no match is found between the generated and stored acceleration pattern data (i.e., determination 808=“No”), the processor 191 may ignore the accelerations and do nothing, step 810. This may allow the processor 191 to differentiate between meaningful acceleration pattern data received from the user and those that may occur haphazardly and due to the natural handling of a mobile device 100. Alternatively, the processor 191 may be configured to inform the user by a default or predetermined vibration pattern that the generated acceleration pattern data does not match a stored acceleration data, step 813.

If a match is found between the detected acceleration pattern and stored acceleration pattern data (i.e., determination 808=“Yes”), the mobile device 100 may execute an action based on the command correlated to the matched acceleration pattern data or template, step 811. For example, the processor 191 may compose and transmit an email to the user's wife with the message “I am stuck in a meeting. I will call you later.”

In an embodiment illustrated in FIG. 15B, in addition to detecting movements caused by a user and composing and transmitting communications based on those movements, a processor 191 may be configured to verify received user commands and confirm transmission of messages by communicating with the user using vibration patterns and receiving communications from the user by detecting additional movements. The processor 191 may detect a first acceleration pattern, step 801. The processor 191 may determine a first pattern of accelerations versus time, step 802, to generate first acceleration pattern data, step 804. The processor 191 may compare the first acceleration pattern data to acceleration pattern data or templates stored in a data table, step 806, to determine whether there is a match, determination 808.

If no match is found between the first and stored acceleration pattern data (i.e., determination 808=“No”), the processor 191 may ignore the accelerations and do nothing, step 810. This may allow the processor 191 to differentiate between meaningful acceleration pattern data received from the user and those that may occur haphazardly and due to the natural handling of a mobile device 100. Alternatively, the processor 191 may be configured to inform the user by a default or predetermined vibration pattern that the first acceleration pattern data received does not match a stored acceleration data, step 813.

If a match is found between the first and stored acceleration data (i.e., determination 808=“Yes”), the processor 191 may execute an action based on the command correlated to the matched acceleration pattern data or template, step 811. The mobile device 100 may inform the user about the match using a confirmation vibration pattern, step 812. For example, to confirm that the recognized acceleration pattern was received, the processor 191 may vibrate the mobile device 100 using a vibration pattern that is similar to or approximately replicates the detected first acceleration pattern. Thus, the user can feel the vibration pattern to determine whether the mobile device correctly detected the intended acceleration pattern.

When a confirmation vibration pattern is felt, the user may confirm that the vibration patterns generated by the mobile device 100 is correct by tapping, patting or moving the mobile device 100 to produce a second acceleration pattern. The processor 191 may detect the second accelerations, step 814, and determine a second pattern of accelerations versus time, step 816, to create second acceleration pattern data, step 818. The processor 191 may compare the second acceleration pattern data to acceleration patterns stored in a database or templates, step 820, to determine whether a match exists between the received and stored acceleration pattern data, determination 822.

If no match exists between the second and stored acceleration patterns or templates (i.e., determination 822=“No”), the processor 191 may alert the user that no match has been found by activating a default or predetermined vibration pattern, step 824, and allow the user to reproduce the second acceleration pattern.

If a match is found between the second and stored acceleration patterns or templates (i.e., determination 822=“Yes”), the processor 191 may determine from the matched pattern or template whether the first acceleration pattern was correctly identified, determination 823. If the first acceleration pattern received was correct (i.e., what the user intended) (i.e., determination 823=“Yes”), the processor 191 may transmit the message, step 826, and then execute a vibration pattern to confirm successful transmission of the message, step 828. If the second acceleration pattern matches a pattern or template which indicates that the first acceleration pattern was received incorrectly (i.e., not what the user intended) (i.e., determination 823=“Yes”), the processor 191 may execute a vibration pattern to prompt the user to restart the entire process, step 825.

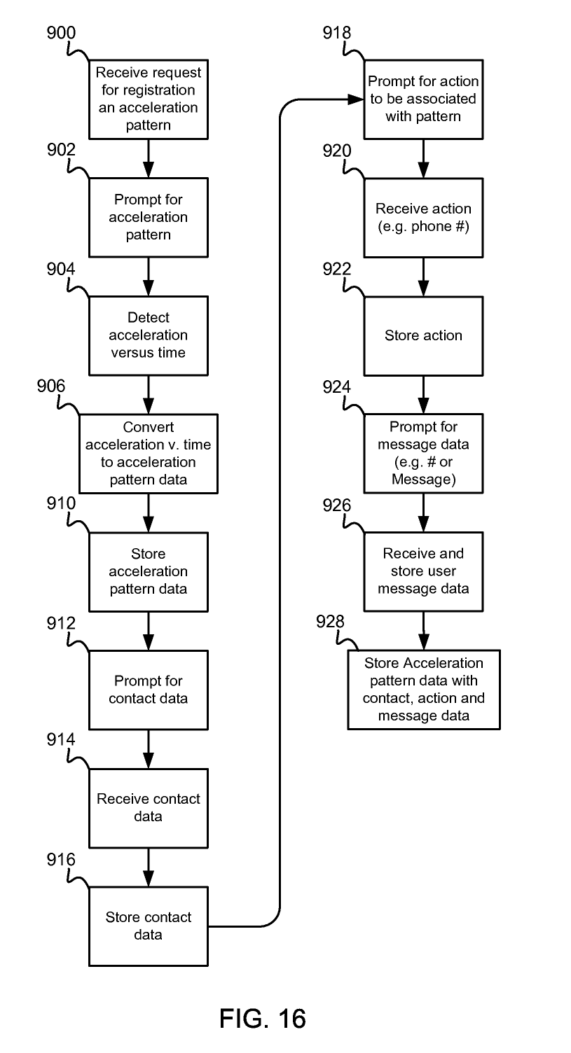

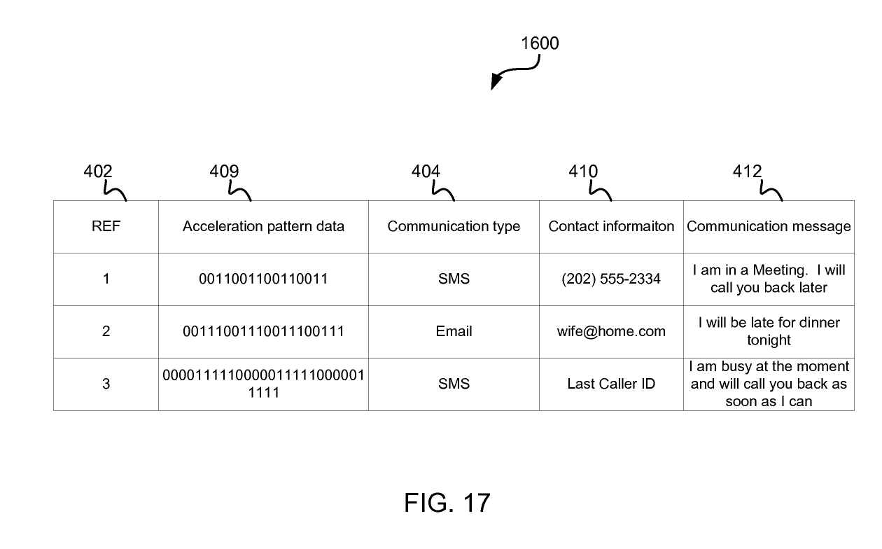

Acceleration pattern data or templates may be generated in a number of different ways. A user may create and store custom acceleration patterns or download and store pre-defined commercial acceleration pattern data. For example, a mobile devices processor 191 may be configured to receive custom acceleration pattern data from a user and record the data in conjunction with user specified meanings. For example, a mobile device 100 user might create and store an acceleration pattern including three shakes in a two second time interval with an assigned meaning to send the SMS message “I can't make lunch” to “Steve.” Generating and storing custom acceleration pattern data is explained in more detail below with reference to FIGS. 16 and 17. Methods for downloading information from the Internet are well known and maybe use to download pre-set acceleration pattern data according to the various embodiments.

FIG. 16 illustrates an embodiment method for generating custom acceleration pattern data for enabling a mobile device 100 to communicate based upon detecting acceleration patterns. The mobile device processor 191 may be configured to receive the request for registering an acceleration pattern, step 900, and generate a display prompting the user to enter an acceleration pattern, step 902, such as by tapping or patting the device in the manner intended to be the pattern. The processor 191 may then detect accelerations versus time, step 904, convert the acceleration values and timing into acceleration pattern data, step 906, and store the acceleration pattern data, step 910. The processor 191 may generate a display prompting the user for contact data to be associated with the pattern, step 912, receive the contact data inputs, step 914, and store the received data in memory 192, step 916. The processor 191 may further be configured with software instructions to generate a display prompting the user for an action command to be associated with the acceleration pattern, such as placing a phone call, or sending an e-mail or SMS message, step 918. The processor 191 may receive the user's action command (e.g. phone number), step 920, and store the data in memory 191, step 922. The processor 191 may also generate a display prompting the user for a predefined message to be transmitted as part of the command action, step 924, and store the received message data in memory 192, step 926. Once all the parameters are received (e.g. contact data, the user command action, and the message data), the processor 191 may store the acceleration pattern data along with the received parameters in an acceleration pattern data table or template, step 928.

FIG. 17 illustrates an embodiment data structure for storing acceleration pattern data and any related command or communication data. An acceleration pattern data table 1600 may include a reference number 402, acceleration pattern data 409, communication type 404, contact information 410, and a communication message 412. Acceleration pattern data 409 may be stored in different formats. For example, as illustrated in FIG. 17 acceleration pattern data 409 may be stored in a binary format. In such a format, each bit symbol “0” may represent a period time that the mobile device 100 does not sense acceleration, and each bit symbol “1” may represent a period of time that the mobile device senses acceleration. The data designated as reference “1” in FIG. 17 includes acceleration pattern data 409 of four periods of non-motion interspersed by four periods of acceleration lasting a total of 2 seconds. As the illustrated example shows, when such an acceleration pattern is detected and recognized, the mobile device 100 may generate and transmit an SMS message to the telephone number “(202) 555-2334” including a message which states “I am in a meeting. I will call you back later.”

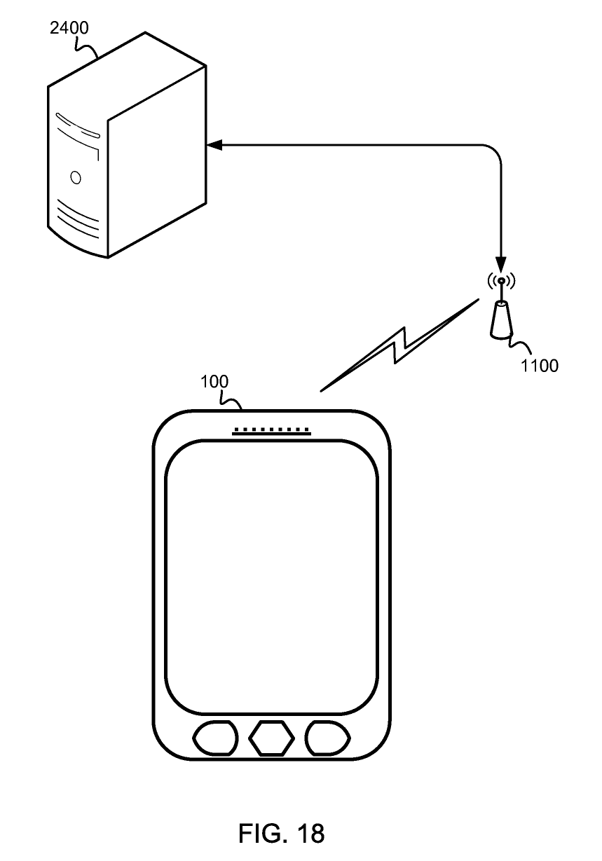

FIG. 18 illustrates a communication network suitable for use with the various embodiments. A mobile device 100 may communicate with a server 2400 using a wireless communication data network via a wireless access point 1100. Using such a network, the mobile device 100 may receive incoming communications as well as access external servers and databases to download vibration or acceleration pattern data. Additionally the mobile device 100 may be configured with software instructions to store vibration and acceleration pattern data and related communication data on the remote server or database and access it when required.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A method, comprising:
receiving a communication including communication data in a mobile device;
locating a first data record based on the received communication data;
obtaining vibration pattern data from the located first data record; and
activating a vibration motor based on the obtained vibration pattern data.

2. The method of claim 1, wherein the vibration pattern data includes intervals of time during which the vibration motor vibrates.

3. The method of claim 1, wherein the vibration pattern data is stored in a binary pattern wherein the binary digit symbol 1 corresponds to a period of vibration and the binary digit symbol 0 corresponds to a period of no vibration.

4. The method of claim 1, further comprising:
prompting a mobile device user to input a vibration pattern;
receiving vibration pattern inputs in the mobile device;
converting the vibration pattern inputs to vibration pattern data; and
storing the vibration pattern data in a second data record.

5. The method of claim 1, further comprising:
displaying a Morse code menu;
receiving a user Morse code selection;
converting the Morse code selection to vibration pattern data; and
storing the vibration pattern data in a second data record.

6. The method of claim 1, wherein obtaining vibration pattern data comprises:
translating a portion of the received communication to Morse code; and
translating the Morse code into vibration pattern data.

7. The method of claim 1, further comprising emitting a sound prior to activating the vibration motor.

8. The method of claim 1, further comprising emitting a sound in addition to activating the vibration motor.

9. A method for communicating, comprising:
detecting a first set of accelerations versus time in a mobile device;
comparing the detected first set of accelerations versus time to a database of accelerations versus time patterns to determine if there is a match;
obtaining stored message data corresponding to a matched accelerations versus time pattern when it is determined that the detected first set of accelerations versus time matches a record in the database of accelerations versus time patterns; and
transmitting a message based on the obtained message data.

10. The method of claim 9, further comprising:
generating vibrations according to a first vibration pattern to indicate that the message was transmitted.

11. The method of claim 9, further comprising:
generating vibrations according to a second vibration pattern before the message is transmitted;
detecting a second set of accelerations versus time; and
comparing the second set of accelerations versus time to the database of acceleration versus time to determine if there a match,
wherein the message is transmitted if it is determined that there is a match between the second set of accelerations versus time and the database of acceleration versus time.

12. The method of claim 11, wherein the second vibration pattern is an approximate replication of the first acceleration pattern.

13. The method of claim 11, further comprising:
receiving an third set of accelerations versus time;
receiving contact data;
receiving an action to be associated with the third set of accelerations versus time;
receiving a message data;
storing the third set of accelerations versus time in a data record of the database correlated to the contact data, the received action and received message data.

14. The method of claim 13, wherein the contact data includes one of a telephone number, and an electronic mail address.

15. The method of claim 13, wherein the received action includes performing an action selected from the group consisting of sending SMSs, sending MMSs, placing phone calls, sending electronic mails, and sending facsimiles.

16. A mobile device comprising:
a transceiver
a vibration motor;
a memory having stored therein vibration pattern data; and
a processor coupled to the transceiver, the memory and the vibration motor, wherein the processor is configured with software to perform steps comprising:
receiving a communication via the transceiver, the communication including communication data;
locating a first data record in the memory based on the received communication data;
obtaining vibration pattern data from the located first data record; and
activating the vibration motor based on the vibration pattern data.

17. The mobile device of claim 16, wherein the vibration pattern data includes intervals of time during which the processor activates the vibration motor.

18. The mobile device of claim 16, wherein the vibration pattern data is stored in the memory in a binary pattern, wherein the binary digit symbol 1 corresponds to a period when the processor activates the vibration motor and the binary digit symbol 0 corresponds to a period when the processor does not activate the vibration motor.

19. The mobile device of claim 16, further comprising:
a display coupled to the processor; and
a user input element coupled to the processor,
wherein the processor is configured with software to perform further steps comprising:
generating an image on the display prompting a user to input a vibration pattern;
receiving vibration pattern user inputs via the user input element;
converting the vibration pattern inputs to vibration pattern data; and
storing the vibration pattern data in a second data record in the memory.

20. The mobile device of claim 16, further comprising:
a display coupled to the processor; and
a user input element coupled to the processor,
wherein the processor is configured with software to perform further steps comprising:
generating an image on the display presenting a Morse code menu;
receiving a Morse code selection user inputs via the user input element;
converting the Morse code selection user inputs to vibration pattern data; and
storing the vibration pattern data in a second data record in the memory.

21. The mobile device of claim 16, wherein the processor is configured with software such that obtaining vibration pattern data includes performing steps comprising:
translating a portion of the communication to Morse code; and
translating the Morse code to vibration pattern data.

22. The mobile device of claim 16, wherein the processor is configured with software to perform further steps comprising emitting a sound prior to activating the vibration motor.

23. The method of claim 1, wherein the processor is configured with software to perform further steps comprising emitting a sound in addition to activating the vibration motor.

24. A mobile device comprising:
means for receiving a communication including communication data;
means for locating a first data record based on the received communication data;
means for obtaining vibration pattern data from the located first data record; and
means for vibrating the mobile device based on the vibration pattern data.

25. The mobile device of claim 24, wherein the vibration pattern data includes intervals of time during which the vibration motor vibrates.

26. The mobile device of claim 24, wherein the vibration pattern data is stored in a binary pattern wherein the binary digit symbol 1 corresponds to a period of vibration and the binary digit symbol 0 corresponds to a period of no vibration.

27. The mobile device of claim 24, further comprising:
means for prompting a user to input a vibration pattern;
means for receiving vibration pattern user inputs;
means for converting the vibration pattern user inputs to vibration pattern data; and
means for storing the vibration pattern data in a second data record.

28. The mobile device of claim 24, further comprising:
means for displaying a Morse code menu;
means for receiving a Morse code selection user input;
means for converting the Morse code selection user input to vibration pattern data; and
means for storing the vibration pattern data.

29. The mobile device of claim 24, wherein means for obtaining vibration pattern data the mobile device comprises:
means for translating a portion of the communication to Morse code; and
means for translating the Morse code to vibration pattern data.

30. A processor readable storage medium having stored thereon processor executable software instructions configured to cause a mobile device processor to perform steps comprising:
receiving a communication including communication data;
locating a first data record based on the received communication data;
obtaining vibration pattern data from the located first data record; and
activating a vibration motor based on the vibration pattern data.

31. The processor readable storage medium of claim 30, wherein the vibration pattern data includes intervals of time during which the vibration motor vibrates.

32. The processor readable storage medium of claim 30, wherein the vibration pattern data is stored in a binary pattern wherein the binary digit symbol 1 corresponds to a period of vibration and the binary digit symbol 0 corresponds to a period of no vibration.

33. The processor readable storage medium of claim 30, wherein the stored processor executable software instructions are configured to cause a mobile device processor to perform steps further comprising:
prompting a user to input a vibration pattern;
receiving vibration pattern user inputs;
converting the vibration pattern user inputs to vibration pattern data; and
storing the vibration pattern data in a second data record.

34. The processor readable storage medium of claim 30, wherein the stored processor executable software instructions are configured to cause a mobile device processor to perform steps further comprising:
displaying a Morse code menu;
receiving a Morse code selection user input;
converting the Morse code selection user input to vibration pattern data; and
storing the vibration pattern data.

35. The processor readable storage medium of claim 30, wherein the stored processor executable software instructions are configured to cause a mobile device processor to obtain vibration pattern data by performing steps further comprising:
translating a portion of the communication to Morse code; and
translating the Morse code to vibration pattern data.

36. The processor readable storage medium of claim 30, wherein the stored processor executable software instructions are configured to cause a mobile device processor to perform further steps comprising emitting a sound prior to activating the vibration motor.

37. The processor readable storage medium of claim 30, wherein the stored processor executable software instructions are configured to cause a mobile device processor to perform further steps comprising emitting a sound in addition to activating the vibration motor.

38. A mobile device, comprising:
an accelerometer;
a memory having stored therein a database of accelerations versus time patterns; and
a processor coupled to the memory and to the accelerometer, wherein the processor is configured with software to perform steps comprising:
receiving acceleration data from the accelerometer;
detecting a first set of accelerations versus time in the received acceleration data;
comparing the first set of detected accelerations versus time to the database of accelerations versus time patterns to determine if there is a match;
obtaining stored message data corresponding to a matched accelerations versus time pattern when it is determined that the detected first set of accelerations versus time matches a record in the database of accelerations versus time patterns; and
transmitting a message based on the obtained message data.

39. The mobile device of claim 38, further comprising a vibration motor coupled to the processor,
wherein the processor is configured with software to perform further steps comprising activating the vibration motor to generate vibrations according to a first vibration pattern to indicate that the message was transmitted.

40. The mobile device of claim 38, further comprising a vibration motor coupled to the processor,
wherein the processor is configured with software to perform further steps comprising:
activating the vibration motor according to a second vibration pattern before the message is transmitted;
detecting a second set of acceleration versus time pattern in the received acceleration data;
comparing the second set of acceleration versus time pattern to the database of accelerations versus time to determine if there a match; and
transmitting the message when it is determined that there is a match between the second set of accelerations versus time and the database of acceleration versus time.

41. The mobile device of claim 40, wherein the second vibration pattern is an approximate replication of the first set of accelerations versus time.

42. The mobile device of claim 40, wherein the processor is configured with software to perform further steps comprising:
detecting a third set of accelerations versus time from the received acceleration data;
receiving contact data;
receiving an action to be associated with the third set of accelerations versus time;
receiving a message data;
storing in the memory the third set of accelerations versus time in a data record in the memory correlated to the contact data, the received action and the received message data.

43. The mobile device of claim 42, wherein the contact data includes one of a telephone number and an electronic mail address.

44. The mobile device of claim 42, wherein the received action includes performing an action selected from the group consisting of sending SMSs, sending MMSs, placing phone calls, sending electronic mails, and sending facsimiles.

45. A mobile device, comprising:
means for detecting a first set of accelerations versus time;
means for comparing the detected first set of accelerations versus time to a database of accelerations versus time patterns to determine if there is a match;
means for obtaining stored message data corresponding to a matched accelerations versus time pattern when it is determined that the detected first set of acceleration versus time matches a record in the database of accelerations versus time patterns; and
means for transmitting a message based on the obtained message data.

46. The mobile device of claim 45, further comprising:
means for generating vibrations according to a first vibration pattern to indicate that the message was transmitted.

47. The mobile device of claim 45, further comprising:
means for generating vibrations according to a second vibration pattern before the message is transmitted;
means for detecting a second set of accelerations versus time pattern; and
means for comparing the second set of accelerations versus time to the database of accelerations versus time to determine if there a match.

48. The mobile device of claim 47, wherein the second vibration pattern is an approximate replication of the first set of accelerations versus time.

49. The mobile device of claim 45, further comprising:
means for receiving an third set of accelerations versus time;
means for receiving contact data;
means for receiving an action to be associated with the third set of accelerations versus time;
means for receiving a message data;
means for storing the third set of accelerations versus time in a data record correlated to the contact data, the received action and the received message data.

50. The mobile device of claim 49, wherein the contact data includes one of a telephone number and an electronic mail address.

51. The mobile device of claim 49, wherein the received action includes performing an action selected from the group consisting of sending SMSs, sending MMSs, placing phone calls, sending electronic mails, and sending facsimiles.

52. A processor readable storage medium having stored thereon processor executable software instructions configured to cause a mobile device processor to perform steps comprising:
detecting a first set of accelerations versus time;
comparing the detected first set of accelerations to a database of accelerations versus time patterns to determine if there is a match;
obtaining stored message data corresponding to a matched accelerations versus time pattern when it is determined that the detected first set of accelerations matches a record in the database of accelerations versus time patterns; and
transmitting a message based on the obtained message data.

53. The processor readable storage medium of claim 52, wherein the stored processor executable software instructions are configured to cause a mobile device processor to perform steps further comprising:
generating vibrations according to a first vibration pattern to indicate that the message was transmitted.

54. The processor readable storage medium of claim 52, wherein the stored processor executable software instructions are configured to cause a mobile device processor to perform steps further comprising:
generating vibrations according to a second vibration pattern before the message is transmitted;
detecting a second acceleration versus time pattern; and
comparing the second acceleration pattern versus time to the database of acceleration versus time to determine if there a match; and
transmitting the message when it is determined that there is a match between the second set of accelerations versus time and the database of acceleration versus time.

55. The processor readable storage medium of claim 54, wherein the second vibration pattern is an approximate replication of the first set of accelerations versus time.

56. The processor readable storage medium of claim 52, wherein the stored processor executable software instructions are configured to cause a mobile device processor to perform steps further comprising:
receiving an third set of accelerations versus time;
receiving contact data;
receiving an action to be associated with the third set of accelerations versus time;
receiving a message data;
storing the third set of accelerations versus time in a data record correlated to the contact data, the received action and the received message data.

57. The processor readable storage medium of claim 56, wherein the contact data includes one of a telephone number and an electronic mail address.

58. The processor readable storage medium of claim 56, wherein the received action includes performing an action selected from the group consisting of sending SMSs, sending MMSs, placing phone calls, sending electronic mails, and sending facsimiles.

59. A method, comprising:
receiving a communication including communication data in a mobile device;
locating a first data record based on the received communication data;
obtaining vibration pattern data from the located first data record; and
activating a speaker based on the obtained vibration pattern data.

60. The method of claim 59, further comprising activating a vibration motor in combination with the speaker based on the obtained vibration pattern data.

61. A mobile device, comprising:
a transceiver
a vibration motor;
a memory having stored therein vibration pattern data; and
a processor coupled to the transceiver, the memory and the vibration motor, wherein the processor is configured with software to perform steps comprising:
receiving a communication including communication data in a mobile device;
locating a first data record based on the received communication data;
obtaining vibration pattern data from the located first data record; and
activating a speaker based on the obtained vibration pattern data.

62. The mobile device of claim 61, wherein the processor is configured with software to perform further steps comprising activating a vibration motor in combination with the speaker based on the obtained vibration pattern data.

63. A mobile device, comprising:
means for receiving a communication including communication data in a mobile device;
means for locating a first data record based on the received communication data;
means for obtaining vibration pattern data from the located first data record; and
means for activating a speaker based on the obtained vibration pattern data.

64. The mobile device of claim 63, further comprising means for activating a vibration motor in combination with the speaker based on the obtained vibration pattern data.

65. A processor readable storage medium having stored thereon processor executable software instructions configured to cause a mobile device processor to perform steps comprising:
receiving a communication including communication data in a mobile device;
locating a first data record based on the received communication data;
obtaining vibration pattern data from the located first data record; and
activating a speaker based on the obtained vibration pattern data.

66. The processor readable storage medium of claim 59, wherein the stored processor executable software instructions are configured to cause a mobile device processor to perform steps further comprising activating a vibration motor in combination with the speaker based on the obtained vibration pattern data.
